(19) United States
(12) Patent Application Publication
(10) Pub. No.: US 2010/0188585 A1
(43) Pub. Date: Jul. 29, 2010

(54) IMAGE DISPLAY SYSTEM, IMAGE DISPLAY APPARATUS, AND IMAGE DISPLAY METHOD

(75) Inventor: Hiroyuki ICHIEDA, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/693,833

(22) Filed: Jan. 26, 2010

(30) Foreign Application Priority Data
Jan. 27, 2009 (JP) 2009-015071

(51) Int. Cl. H04N 9/64; H04N 5/44; H04N 9/12; H04N 9/31

(52) U.S. Cl. 348/708; 348/725; 348/739; 348/744; 348/E05.096; 348/E09.037; 348/E09.012; 348/E09.025

(57) ABSTRACT

An image display system in which an image display apparatus displays an image based on an image signal supplied from an image signal supply apparatus, wherein the image display apparatus includes: an image display unit displaying the image based on the image signal; an input source switching unit switching an input source of the image signal corresponding to the image displayed by the image display unit; a communication setup unit setting up a communication path with the image signal supply apparatus; a switching controller controlling the input source switching unit to switch the input source to the image signal supply apparatus in response to the notification that the communication setup unit sets up the communication path; and an image receiver receiving the image signal supplied from the image signal supply apparatus, and wherein the image signal supply apparatus includes an image transmitter transmitting the image signal to the image display apparatus via the communication path after the switching controller switches the input source.

The entire disclosure of Japanese Patent Application No. 2009-015071 filed Jan. 27, 2009 is expressly incorporated by reference herein.

### BACKGROUND

1. Technical Field

The present invention relates to an image display system having an image signal supply apparatus and an image display apparatus, and an image display apparatus.

2. Related Art

In presentations and the like, generally, a projector and a document camera are effectively used to project an image taken by the document camera by the use of the projector. As such an image display system, a configuration has been suggested in which the document camera and the projector are connected to a computer and the computer controls the document camera to take an image of an original material and controls the projector to project the image acquired by imaging when the document camera is turned on (see JP-A-2005-79730). According to this configuration, when the document camera is turned on, the original material can be automatically projected (see JP-A-2005-79730).

However, in the related art, since the computer is disposed between the projector and the document camera, it is necessary to operate the computer and thus a user unaccustomed to a mechanical operation could not easily operate the system.

### SUMMARY

An advantage of some aspects of the invention is to allow a user unaccustomed to a mechanical operation to operate the system easily.

The invention can be embodied in the following aspects.

According to an aspect of the invention, there is provided an image display system in which an image display apparatus displays an image based on an image signal supplied from an image signal supply apparatus. Here, the image display apparatus includes: an image display unit displaying the image based on the image signal; an input source switching unit switching an input source of the image signal corresponding to the image displayed by the image display unit; a communication setup unit setting up a communication path with the image signal supply apparatus; a switching controller controlling the input source switching unit to switch the input source to the image signal supply apparatus in response to the notification that the communication setup unit sets up the communication path; and an image receiver receiving the image signal supplied from the image signal supply apparatus. In addition, the image signal supply apparatus includes an image transmitter transmitting the image signal to the image display apparatus via the communication path after the switching controller switches the input source.

According to this configuration, when a communication path is set up between the image signal supply apparatus and the image display apparatus, the image display apparatus causes the switching controller to automatically switch the input source to the image signal supply apparatus. Thereafter, an image is transmitted from the image transmitter of the image signal supply apparatus and the image receiver of the image display apparatus receives the transmitted image. Accordingly, a user can simply display an image acquired by the image signal supply apparatus on the image display apparatus, only by connecting the image signal supply apparatus to the image display apparatus via a predetermined transmission cable.

In the image display system, the image signal supply apparatus and the image display apparatus may include USB interfaces, respectively. In this case, the communication setup unit may include: a USB connection detector detecting a connection to the image signal supply apparatus via the USB interface; and a configuration setter acquiring a configuration descriptor of the image signal supply apparatus. Here, the image display apparatus may further include a stream negotiation unit determining a condition for transmitting and receiving the image on the basis of the configuration descriptor acquired by the configuration setter.

According to this configuration, since the image display system includes the USB interfaces, it is possible to determine the condition for transmitting and receiving the image on the basis of the configuration descriptor based on the USB standard and acquired by the configuration setter, only by connecting the image signal supply apparatus to the image display apparatus via the USB cable as a predetermined transmission cable. As a result, the convenience to a user is excellent.

In the image display system, the configuration descriptor may include at least type data for defining a color space of the image acquired by the image signal supply apparatus, and the image display apparatus may include an image color corrector correcting colors of the image received by the image receiver on the basis of the type data.

According to this configuration, the image acquired by the image signal supply apparatus is corrected in color so as to be fully reproduced in the color gamut of the image display apparatus. Accordingly, the image display system is excellent in color reproducibility.

In the image display system, the image display apparatus may further include: a standby state determining unit determining whether the image display apparatus is in a standby state until the switching controller switches the input source after the communication setup unit sets up the communication path; and an activation unit switching the image display apparatus from the standby state to an ON state when the standby state determining unit determines that the image display apparatus is in the standby state.

According to this configuration, when the image display apparatus is in the standby state after the communication path is set up between the image signal supply apparatus and the image display apparatus, the image display apparatus is automatically changed to the ON state. Accordingly, it is possible to display the image acquired by the image signal supply apparatus on the image display apparatus simply and satisfactorily.

According to another aspect of the invention, there is provided an image display apparatus displaying an image based on an image signal supplied from an image signal supply apparatus, including: an input source switching unit switching an input source of the image displayed by the image display unit; a communication setup unit setting up a communication due to the USB interface and a switching controller controlling the input source switching unit to switch the input source to the image signal supply apparatus in response to the notification that the communication setup unit sets up the communication.

According to this configuration, when a communication path is set up between the image signal supply apparatus and the image display apparatus, the switching controller automatically switches the input source to the image signal supply apparatus. Accordingly, similarly to the image display system, a user can simply display an image acquired by the image signal supply apparatus on the image display apparatus, only by connecting the image signal supply apparatus to the image display apparatus.

In another image display apparatus, the elements of the image display system may be added to the above-mentioned image display apparatus.

The invention can be modified in various forms and can be embodied in the forms of a method for embodying the units of the image signal supply apparatus or the image display apparatus, a computer program for embodying the units, a recording medium having recorded thereon the computer program, and data signals embodied by carrier waves including the computer program.

### BRIEF DESCRIPTION OF THE DRAWINGS

The invention will be described with reference to the accompanying drawings, wherein like numbers reference like elements.

FIG. 1 is a diagram schematically illustrating a configuration of a projector system according to an embodiment of the invention.

FIG. 2 is a diagram illustrating an internal configuration of a projector and a document camera.

FIG. 3 is a flowchart illustrating a connecting process performed by controllers of the projector and the document camera.

FIG. 4 is a diagram illustrating the internal configuration of a projection unit of the projector.

### DESCRIPTION OF EXEMPLARY EMBODIMENTS

Hereinafter, exemplary embodiments of the invention will be described with reference to the accompanying drawings.

### 1. Hardware Configuration

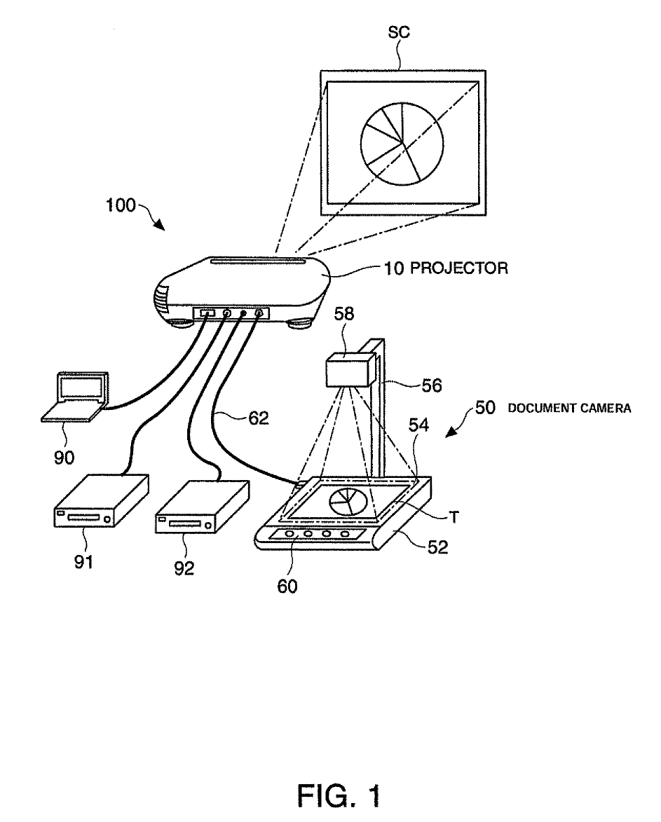

FIG. 1 is a diagram schematically illustrating a projector system according to an embodiment of the invention. As shown in the drawing, the projector system 100 includes a projector 10 and four image input apparatuses connected to the projector 10, such as a document camera 50, a personal computer 90, a video tape recorder (VTR) 91, and a DVD player 92. These image input apparatuses provide input sources of images to the projector 10. Here, the image may be any of a still image and a moving image (that is, video). The document camera 50 acquires an image. The projector 10 selects a desired input source from the input sources and displays (projects) an image on a screen SC on the basis of the selected input source.

The document camera 50 includes a base member 52, a mounting plane 54, an arm 56, a camera head 58, and an operation panel 60. The mounting plane 54 is disposed on the base member 52 and a subject T such as a sheet of paper having characters or figures drawn thereon and a stereoscopic object is mounted thereon. The arm 56 holds the camera head 58. The camera head 58 includes a lens, an LED, and a photoelectric conversion device such as a CCD and takes an image of the subject T mounted on the mounting plane 54. The operation panel 60 includes plural buttons (button type switches) and allows a user to input an operating instruction to the document camera 50.

The arm 56 may extend upward from the base member 52 and then fixed, or may foldably rotate toward the base member 52. By constructing the arm so as to be foldable, the document camera 50 can be compactly arranged. At the time of use, the folding of the arm 56 is released to unfold the arm.

The document camera 50 having the above-mentioned configuration takes an image of the subject T mounted on the mounting plane 54 and outputs an image signal indicating the taken image to the projector 10. The projector 10 and the document camera 50 are USB-connected to each other with a USB cable 62. That is, the projector 10 and the document camera 50 are connected to each other directly via the USB interfaces.

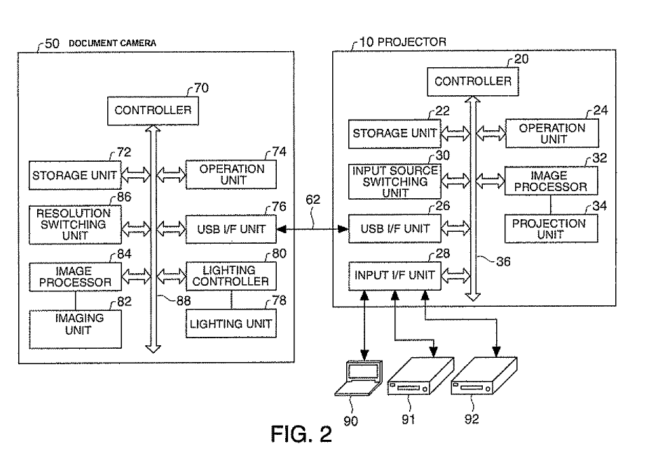

FIG. 2 is a diagram illustrating the internal configuration of the projector 10 and the document camera 50. As shown in the drawing, the projector 10 includes a controller 20, a storage unit 22, an operation unit 24, a USB interface unit 26, an input interface unit 28, an input source switching unit 30, an image processor 32, and a projection unit 34. Reference numeral 36 represents a bus and connects the controller 20 to the units 22 to 32 other than the projection unit 34.

The controller 20 is constructed by a CPU or the like and operates in accordance with computer programs stored in the storage unit 22 to control the units 22 to 32. The storage unit 22 stores image data or various computer programs. A known USB module, a USB video class driver, an image display program, and a program for a connecting process to be described later are stored as the computer programs.

The operation unit 24 serves to input an operation instruction from the user to the projector 10 and includes an operation panel (not shown) and a remote controller receiver (not shown). The operation panel and the remote controller are provided with an input source switching button (not shown) for switching an input source of an image to be displayed by the projector 10.

The USB interface unit 26 is an interface used to transmit and receive control data or image data to and from an external device on the basis of a USB (Universal Serial Bus) standard. In this embodiment, the document camera 50 is connected to the USB interface unit 26.

The input interface unit 28 is an interface used to transmit and receive control data and image data to and from an external device other than a USB, and includes an RGB interface, a video interface, and an S-video interface. The RGB interface is connected to the personal computer 90, the video interface is connected to the VTR 91, and the S-video interface is connected to the DVD player 92.

The input source switching unit 30 switches the input source of the image to be displayed by the projector 10 by selecting one interface out of the USB interface unit 26 and the interfaces included in the input interface unit 28.

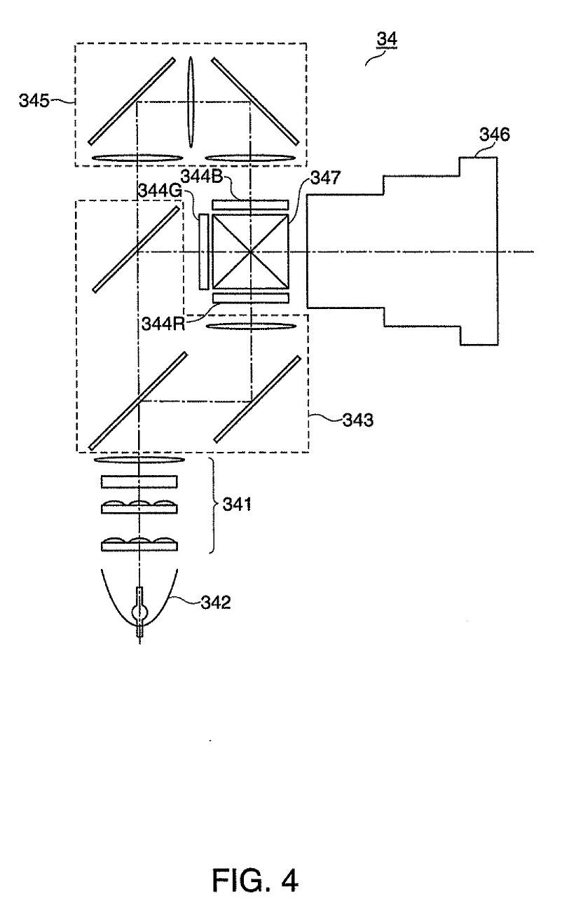

The image processor 32 generates display image data for image display on the basis of the image data or video data input from the interface selected by the input source switching unit 30. As shown in FIG. 4, the projection unit 34 includes a light source 342, light modulators 344 (344R, 344G, and 344B), a projection lens 346, a lighting optical system 341, a color separating optical system 343, a relay optical system 345, and a synthesis optical system 347. The projector 10 according to this embodiment includes a transmissive liquid crystal panel as the light modulators 344. White light emitted from the light source 342 is separated into a beam, a green beam, and a blue beam while passing through the lighting optical system 341, the color separating optical system 343, and the relay optical system 345, and the separated beams are modulated by the light modulators 344 on the basis of the display image data generated by the image processor 32 and are incident on the synthesis optical system 347. The color image beams modulated by the light modulators 344 are synthesized by the synthesis optical system 347 and the synthesized image light is projected from the projection lens 346. The synthesis optical system 347 can be constructed by a dichroic prism or the like.

The document camera 50 includes a controller 70, a storage unit 72, an operation unit 74, a USB interface unit 76, a lighting unit 78, a lighting controller 80, an imaging unit 82, an image processor 84, and a resolution switching unit 86. Reference numeral 88 represents a bus and connects the controller 70 to the units 72 to 76, 80, 84, and 86 other than the lighting unit 78 and the imaging unit 82.

The controller 70 is constructed by a CPU or a DSP, and operates in accordance with computer programs stored in the storage unit 72 so as to control the units 70 to 86 included in the document camera 50. The storage unit 72 stores image data or various computer programs. A known USB module, a USB class driver, and a program for a connecting process to be described later are stored as the computer programs.

The operation unit 74 serves to input an operation instruction from a user to the document camera and includes an operation panel 60 (see FIG. 1) disposed in the document camera 50.

The USB interface unit 76 serves to transmit and receive control data or image data to and from an external device on the basis of the USB standard. In this embodiment, the USB interface unit 76 is connected to the USB interface unit 26 of the projector 10. Both USB interface units 26 and 76 correspond to the “USB interface” described in the claims.

The lighting unit 78 includes a light source such as an LED emitting light to the subject T. The lighting controller 80 controls the turning-on and turning-off of the lighting unit 78. The imaging unit 82 includes a photoelectric conversion device such as a CCD and a driving unit controlling an AE (automatic exposure)/AF (automatic focus) control operation. The imaging unit 82 is built in the camera head 58 (see FIG. 1). The image processor 84 performs an image process such as white balancing on the image signal corresponding to the image taken by the imaging unit 82. The resolution switching unit 86 switches the resolution of the image taken by the imaging unit 82 into a resolution requested by the projector 10. The request of the projector 10 is sent from the projector 10 via the USB I/F unit 76.

The document camera 50 is supplied with power from the projector 10 via a USB interface unit 26.

The projector 10 and the document camera 50 having the above-mentioned configurations operate as follows to display an image of the subject T (see FIG. 1). That is, when the operation unit 74 of the document camera 50 is operated, the controller 70 controls the lighting controller 80, the image processor 84, and the resolution switching unit 86 to take an image of the subject T mounted on the mounting plane 54 (see FIG. 1), and temporarily stores the image signal (image data) acquired by imaging in the storage unit 72. Thereafter, the controller 70 transmits the image signal stored in the storage unit 72 to the projector 10 via the USB I/F unit 76.

In the projector 10, the controller 20 receives the image signal transmitted from the document camera 50 via the USB I/F unit 26 and controls the image processor 32 to generate the display image data on the basis of the received image signal. As a result, a projection beam modulated on the basis of the display image data is projected by the projection unit 34. Finally, the image of the subject T is displayed on the screen SC (see FIG. 1).

As described above, the projector 10 includes various input sources in addition to the document camera 50. When a user operates the input source switching button (not shown) included in the operation unit 24, the controller 20 of the projector 10 activates the input source switching unit 30 to select one interface out of the USB interface unit 26 and the interfaces of the input interface unit 28, whereby the input source of an image to be displayed by the projector 10 is switched.

In this embodiment, when the document camera 50 is connected to the projector 10, the projecting of the image taken by the document camera 50 using the projector is automatically started. The operations of the projector 10 and the document camera 50 when the projector 10 and the document camera 50 are connected to each other will be described in detail.

### 2. Software Configuration

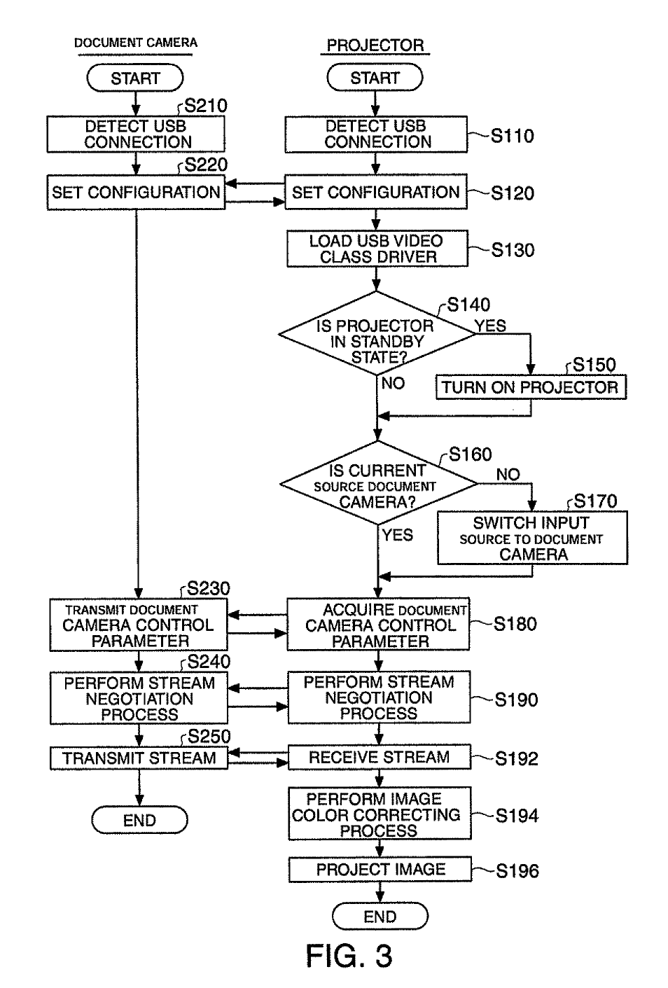

FIG. 3 is a flowchart illustrating a connecting process performed by the controllers 20 and 70 of the projector 10 and the document camera 50. The right side of the drawing shows the connecting process in the controller 20 of the projector 10, and the left side shows the connecting process in the controller 70 of the document camera 50.

When the flow of processes is started, the controllers (hereinafter, referred to as “projector controller” and “document camera controller”, respectively) 20 and 70 first perform a process of detecting the USB connection between the projector 10 and the document camera 50 (steps S110 and S210). In this process, it is detected that the USB interface unit 26 of the projector 10 and the USB interface unit 76 of the document camera 50 are connected using the USB cable 62. Although not shown, the power supply from the projector 10 to the document camera 50 via the USB cable 62 is started by the connection. The controllers 20 and 70 wait for the detection of connection when the connection is not detected.

The controllers 20 and 70 sets a configuration (steps S120 and S220) when the USB connection is detected. Specifically, the projector controller 20 requests a configuration descriptor from the document camera 50 and the document camera controller 70 returns the configuration descriptor to the projector 10 in response to the request. The projector controller 20 acquires the configuration descriptor transmitted from the document camera 50.

The descriptor includes the configuration descriptor indicating that the document camera 50 operates as an apparatus based on the USB standard. The configuration descriptor includes a list of functions for controlling the projector 10 by the functions of the document camera 50, supported frame resolutions, supported frame formats (MJPEG/YUV), and types of color spaces (sRGB/BT.470-2(M)/BT.470-2(R,G)/SMPTE170M/SMPTE240M). As for the types of the color spaces, a color space used in the document camera 50 is determined and the determined color space is included in the configuration descriptor.

The setting of configuration in steps S120 and S220 is performed actually in the process of enumeration started after the USB connection is detected. That is, the enumeration process based on the USB standard is actually performed, but only the setting of configuration which is an important element is described in the flowchart.

The projector controller 20 loads a USB video class driver (step S130) when the descriptor is normally acquired. Specifically, the USB video device class is detected on the basis of the device class information included in the descriptor and the USB video class driver is loaded. The following processes are performed using the loaded USB video class driver as needed.

After performing the process of step S130, the projector controller 20 determines whether the projector 10 is in the standby state (step S140), and turns on the projector 10 when it is determined that the projector is in the standby state (step S150). After performing the process of step S150, the process of step S160 is performed. When it is determined in step S140 that the projector is not in the standby state, that is, that the projector is in the ON state, the process of step S160 is performed.

In step S160, the projector controller 20 determines whether the current input source of the projector 10, that the current source, is the document camera 50. Here, when it is determined that the current source is not the document camera 50, a process of switching the input source of the projector 10 to the document camera 50 is performed (step S170). Specifically, the input source switching unit 30 is activated to switch the input source of the image displayed by the projector 10 to the document camera 50. The processes of steps S160 and S170 correspond to the “switching controller” in the claims. After the process of step S170, the process of step S180 is performed. When it is determined in step S160 that the current source is the document camera 50, the process of step S180 is performed.

In step S180, the projector controller 20 performs a process of acquiring control parameters of the document camera 50. In this process, various control parameters of the document camera 50 are requested and the various control parameters transmitted from the document camera 50 in response to the request are acquired. The control parameters include, for example, the set range values (Min/Max) of the functions (zoom, adjustment of contrast, adjustment of brightness, and the like) of the document camera 50 which can be controlled by the projector 10 and the current set values of the functions. The control parameters are used in the processes of the projector 10 not shown as needed.

When the request for the control parameters is received from the projector controller 20, the document camera controller 70 transmits the control parameters to the projector 10 in response to the request (step S230).

The projector controller 20 performs a stream negotiation process (step S190) after performing the process of step S180. Here, the stream negotiation process is a process of setting the projector 10 on the basis of the configuration descriptor acquired in step S120. The document camera controller 70 similarly performs the stream negotiation process in cooperation with the projector controller 20 (step S240). The processes of steps S190 and S240 serve to determine the conditions for transmitting a stream (image data), such as a frame resolution, a frame format, an interval, and a bandwidth.

The document camera controller 70 transmits the stream (step S250) under the conditions determined in step S240 after performing the process of step S240. The projector controller 20 requests the document camera 50 to transmit a stream after performing the process of step S190, and receives the stream transmitted in step S250 (step S192). Thereafter, the projector controller 20 performs a process of correcting the colors of the image data which is the stream received in the step S192 (step S194) on the basis of the type of the color space included in the configuration descriptor acquired in step S120. That is, the projector controller 20 operates the image processor 32 to generate display image data by performing a color matching process so as to reproduce fully the target characteristic in the color gamut of the projector 10, and sets the target characteristic in step S194 on the basis of the type of the color space acquired in step S180. As a result, the display image data is corrected in color so as to be fully reproduced in the color gamut of the projector 10.

Subsequently, the projector controller 20 operates the projection unit 34 to project the display image data generated in step S194 (step S196). Thereafter, the projector controller 20 ends the connecting process. The document camera controller 70 ends the connecting process after performing the process of step S250.

3. Operations and Advantages

In the projector system 100 according to this embodiment having the above-mentioned configuration, when a communication path between the document camera 50 and the projector 10 is set up using the USB interface, the projector 10 automatically switches the input source to the document camera 50. Thereafter, the stream is transmitted from the document camera 50 and the projector 10 receives the stream. Accordingly, a user can easily display the image taken by the document camera 50 by the use of the projector 10, only by USB-connecting the projector 10 and the document camera 50.

In the projector system 100 according to this embodiment, when the projector 10 is in the standby state after the communication path between the document camera and the projector 10 is set up using the USB interface, the power source of the projector 10 is automatically changed to the ON state. The projector 10 automatically switches the input source to the document camera 50. Accordingly, it is possible to display the image taken by the document camera 50 by the use of the projector 10 simply and satisfactorily.

In this embodiment, since the projector 10 corrects the colors on the basis of the type of the color space included in the configuration descriptor acquired by the setting of configuration, the image taken by the document camera 50 is corrected in color so as to reproduce fully the image in the color gamut of the projector 10. Accordingly, the color reproducibility in the projector 10 is excellent.

### 4. Modified Examples

The invention is not limited to the above-mentioned embodiments or the modified examples thereof, but may be modified in various forms without departing from the spirit and scope of the invention. For example, the following modified examples can be employed.

(1) Although it has been described in the above-mentioned embodiment that the control parameters of the document camera are acquired and transmitted (in steps S180 and S230) in the connecting process of the projector and the document camera 50 of the projector system 100, the process of acquiring and transmitting the control parameters may not be performed. Although it has been described in the above-mentioned embodiment that the image color correcting process is performed in step S194, the image color correcting process may not be performed. The process of switching the input source to the document camera 50 in steps S160 and S170 may be performed just after step S180 or just after step S190.

(2) Although it has been described in the above-mentioned embodiment that the document camera 50 is used as the image signal supply apparatus, another image signal supply apparatus such as a web camera, a digital still camera, and a video camera having an imaging unit may be employed.

(3) Although the projector 10 including the transmissive liquid crystal panels as the light modulators 344 has been exemplified as the image display apparatus in the above-mentioned embodiment, a reflective liquid crystal panel or a micro mirror device may be employed as the light modulators 344. Although it has been described in the above-mentioned embodiment that the projector 10 employing three light modulators 344 is employed, the number of light modulators 344 is not limited to three. For example, a rotating color wheel may be disposed in the lighting optical system 341 and the color light beams may be generated in a time divisional manner using a single light modulator 344. Four or more light modulators 344 may be employed.

(4) Although the projector 10 projecting an image on an external screen SC is used as the image display apparatus in the above-mentioned embodiment, a projection television including a screen and a projector projecting an image to the back surface of the screen may be employed instead. Not limited to the projector, various image display apparatuses such as various direct-viewing flat panel display apparatuses may be employed.

(5) it has been described in the above-mentioned embodiment that the projector 10 as the image display apparatus and the document camera 50 as the image signal supply apparatus are connected to each other by a USB cable 62. Not limited to the wired connection, a wireless connection using a USB may be employed.

(6) Some elements embodied by hardware in the above-mentioned embodiment may be replaced with software. On the contrary, some elements embodied by software may be replaced with hardware.

What is claimed is:

1. An image display system in which an image display apparatus displays an image based on an image signal supplied from an image signal supply apparatus,
wherein the image display apparatus includes:
an image display unit displaying the image based on the image signal;
an input source switching unit switching an input source of the image signal corresponding to the image displayed by the image display unit;
a communication setup unit setting up a communication path with the image signal supply apparatus;
a switching controller controlling the input source switching unit to switch the input source to the image signal supply apparatus in response to the notification that the communication setup unit sets up the communication path; and
an image receiver receiving the image signal supplied from the image signal supply apparatus, and
wherein the image signal supply apparatus includes
an image transmitter transmitting the image signal to the image display apparatus via the communication path after the switching controller switches the input source.

2. The image display system according to claim 1, wherein the image signal supply apparatus and the image display apparatus include USB interfaces, respectively,
wherein the communication setup unit includes:
a USB connection detector detecting a connection to the image signal supply apparatus via the USB interface; and
a configuration setter acquiring a configuration descriptor of the image signal supply apparatus, and
wherein the image display apparatus further includes a stream negotiation unit determining a condition for transmitting and receiving the image on the basis of the configuration descriptor acquired by the configuration setter.

3. The image display system according to claim 2, wherein the configuration descriptor includes at least type data for defining a color space of the image acquired by the image signal supply apparatus, and
wherein the image display apparatus includes an image color corrector correcting colors of the image received by the image receiver on the basis of the type data.

4. The image display system according to claim 1, wherein the image display apparatus further includes:
a standby state determining unit determining whether the image display apparatus is in a standby state until the switching controller switches the input source after the communication setup unit sets up the communication path; and
an activation unit switching the image display apparatus from the standby state to an ON state when the standby state determining unit determines that the image display apparatus is in the standby state.

5. An image display apparatus displaying an image based on an image signal supplied from an image signal supply apparatus, comprising:
an image display unit displaying the image based on the image signal;
an input source switching unit switching an input source of the image signal corresponding to the image displayed by the image display unit;
a communication setup unit setting up a communication path with the image signal supply apparatus;
a switching controller controlling the input source switching unit to switch the input source to the image signal supply apparatus in response to the notification that the communication setup unit sets up the communication path; and
an image receiver receiving the image signal supplied from the image signal supply apparatus via the communication path.

6. The image display apparatus according to claim 5, further comprising a USB interface connected to the image signal supply apparatus,
wherein the communication setup unit includes:
a USB connection detector detecting a connection to the image signal supply apparatus via the USB interface; and
a configuration setter acquiring a configuration descriptor of the image signal supply apparatus, and
wherein the image display apparatus further comprises a stream negotiation unit determining a condition for transmitting and receiving the image on the basis of the configuration descriptor acquired by the configuration setter.

7. The image display apparatus according to claim 6, wherein the configuration descriptor includes at least type data for defining a color space of the image acquired by the image signal supply apparatus, and
wherein the image display apparatus further comprises an image color corrector correcting colors of the image received by the image receiver on the basis of the type data.

8. The image display apparatus according to claim 5, further comprising:
a standby state determining unit determining whether the image display apparatus is in a standby state until the switching controller switches the input source after the communication setup unit sets up the communication path; and
an activation unit switching the image display apparatus from the standby state to an ON state when the standby state determining unit determines that the image display apparatus is in the standby state.

9. The image display apparatus according to claim 5, wherein the image display unit is a projector including:
a light source;
a light modulator modulating light emitted from the light source into image light on the basis of the image signal; and
a projection lens projecting the image light.

10. An image display method in an image display system in which an image display apparatus displays an image based on an image signal supplied from an image signal supply apparatus,
the image display method causing the image display apparatus to perform:
preparing an image display unit displaying the image based on the image signal;
preparing an input source switching unit switching an input source of the image signal corresponding to the image displayed by the image display unit;
preparing a communication setup unit setting up a communication path with the image signal supply apparatus;
controlling the input source switching unit to switch the input source to the image signal supply apparatus in response to the notification that the communication setup unit sets up the communication path; and
receiving the image signal supplied from the image signal supply apparatus, and
the image display method causing the image signal supply apparatus to perform transmitting the image signal to the image display apparatus via the communication path after the switching controller switches the input source.
